(19) United States
(12) Patent Application Publication
(10) Pub. No.: US 2014/0133416 A1
(43) Pub. Date: May 15, 2014

(54) Methods, Apparatus and Computer Programs for Controlling Operation of a Wireless Device

(71) Applicant: BROADCOM CORPORATION, Irvine, CA (US)

(72) Inventors: Keiichi KUBOTA, Surrey (GB); Kundan Kumar LUCKY, Bangalore (IN); Stuart Ian GEARY, Fleet (GB)

(73) Assignee: BROADCOM CORPORATION, Irvine, CA (US)

(21) Appl. No.: 14/078,771

(22) Filed: Nov. 13, 2013

(30) Foreign Application Priority Data
Nov. 14, 2012 (GB) 1220510.0

(51) Int. Cl. H04L 5/00

(52) U.S. Cl. CPC H04L 5/0092
USPC 370/329

(57) ABSTRACT

Wireless devices operate under network control. The network sends access control information for receipt by wireless devices that are operating in a suspended connected mode or idle mode under control of the network. The access control information operates to control access to the network by the wireless devices regardless of whether the wireless devices are operating in a suspended connected mode or idle mode.

### CROSS REFERENCE TO RELATED APPLICATION

This application claims the benefit under 35 U.S.C. §119(a) and 37 CFR §1.55 to UK patent application no. 1220510.0, filed on Nov. 14, 2012, the entire content of which is incorporated herein by reference.

### TECHNICAL FIELD

The present invention relates to methods, apparatus and computer programs for controlling operation of a wireless device.

### BACKGROUND

The following abbreviations which may be found in the specification and/or the drawing figures are defined as follows:

3GPP Third Generation Partnership Project

BCCH Broadcast Control Channel

CBS Cell Broadcast Service

DSAC Domain Specific Access Control

ETWS Earthquake and Tsunami Warning System

LTE Long Term Evolution

PPAC Paging Permission with Access Control

RRC radio resource control

SI system information

SIM subscriber identity module

UE user equipment

UMTS Universal Mobile Telecommunications System

URA UTRAN registration area

UTRA UMTS Terrestrial Radio Access

UTRAN UMTS Terrestrial Radio Access Network

In a wireless network, there will typically be occasions where a network operator needs to restrict or control access to the network by wireless devices. It may be for example that the network is becoming overloaded and therefore access to the network by the wireless devices needs to be controlled in order to prevent congestion and the like. Alternatively or additionally, there will typically be some access to the network that the network would like to prioritize, for example to allow voice calls to or from emergency services to be made, or to ensure that particular messages are likely to be received by the wireless devices.

### SUMMARY

In a first exemplary embodiment of the invention, there is a method of controlling operation of wireless devices operating under network control, the method comprising:
the network sending access control information for receipt by wireless devices that are operating in a suspended connected mode or idle mode under control of the network, the access control information operating to control access to the network by the wireless devices regardless of whether the wireless devices are operating in a suspended connected mode or idle mode.

In a second exemplary embodiment of the invention, there is a method of controlling operation of a wireless device operating under network control, the method comprising:
the wireless device receiving access control information from the network while operating in a suspended connected mode or idle mode under control of the network, the access control information operating to control access to the network by the wireless device regardless of whether the wireless device is operating in a suspended connected mode or idle mode.

In a third exemplary embodiment of the invention, there is apparatus for controlling operation of wireless devices operating under network control, the apparatus comprising:
at least one processor;
and at least one memory including computer program code;
the at least one memory and the computer program code being configured to, with the at least one processor, cause the apparatus at least to:
send access control information for receipt by wireless devices that are operating in a suspended connected mode or idle mode under control of the network, the access control information operating to control access to the network by the wireless devices regardless of whether the wireless devices are operating in a suspended connected mode or idle mode.

In a fourth exemplary embodiment of the invention, there is apparatus for a wireless device operating under network control, the apparatus comprising:
at least one processor;
and at least one memory including computer program code;
the at least one memory and the computer program code being configured to, with the at least one processor, cause the apparatus at least to:
control access to the network by the wireless device in accordance with access control information received from the network while the wireless device is operating in a suspended connected mode or idle mode under control of the network, the access control information operating to control access to the network by the wireless device regardless of whether the wireless device is operating in a suspended connected mode or idle mode.

There may be provided a computer program comprising instructions such that when the computer program is executed by a processing system of a wireless device, the wireless device is arranged to carry out any of the methods as described above.

The processing systems described above may comprise at least one processor and at least one memory including computer program instructions, the at least one memory and the computer program instructions being configured to, with the at least one processor, cause the apparatus at least to perform as described above.

There may also be provided a computer program comprising instructions such that when the computer program is executed on apparatus for controlling operation of wireless devices operating under network control, the apparatus is arranged to:
send access control information for receipt by wireless devices that are operating in a suspended connected mode or idle mode under control of the network, the access control information operating to control access to the network by the wireless devices regardless of whether the wireless devices are operating in a suspended connected mode or idle mode.

There may also be provided a computer program comprising instructions such that when the computer program is executed on processing system of a wireless device operating under network control, the wireless device is arranged to:
control access to the network by the wireless device in accordance with access control information received from the network while the wireless device is operating in a suspended connected mode or idle mode under control of the network, the access control information operating to control access to the network by the wireless device regardless of whether the wireless device is operating in a suspended connected mode or idle mode.

There may be provided a non-transitory computer-readable storage medium comprising a set of computer-readable instructions stored thereon, which, when executed by a processing system, cause the processing system to carry out any of the methods as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically a wireless device and a network arrangement;

FIG. 2 shows schematically an example of an embodiment of the present invention; and

FIG. 3 shows schematically another example of an embodiment of the present invention.

### DETAILED DESCRIPTION

Examples of embodiments of the present invention allow control of access to the network by wireless devices regardless of whether the wireless devices are operating in a suspended connected mode (such as a paging channel state for example, including for example CELL_PCH and URA_PCH) or idle mode. Major changes to the signaling used by the network are avoided, which makes this relatively straightforward to implement in practice.

In an exemplary embodiment of the first exemplary embodiment, the access control information is such as to restrict a wireless device initiating at least one of an RRC Connection Request, a cell update and a UTRAN registration area URA update.

In an exemplary embodiment of the first exemplary embodiment, the access control information is such as to prevent a wireless device initiating at least one of an RRC Connection Request, a UTRAN registration area URA update and a cell update when the update cause is set to either “Uplink data transmission” or “Paging response”.

In an exemplary embodiment of the first exemplary embodiment, the access control information is such as to prevent a wireless device initiating at least one of an RRC Connection Request, a cell update and a UTRAN registration area URA update following receipt by the wireless device of an Earthquake and Tsunami Warning System ETWS primary notification.

In an exemplary embodiment of the first exemplary embodiment, the access control information is sent as part of information relating to at least one of Access Class Barred List, Paging Permission with Access Control PPAC and Domain Specific Access Control DSAC. Each of Access Class Barred List, Paging Permission with Access Control PPAC and Domain Specific Access Control DSAC is a technique that is known in itself, but has to date only been applied to wireless devices that are operating in an idle mode.

In an exemplary embodiment of the first exemplary embodiment, the access control information includes an indication that the information applies to a wireless device operating in a suspended connected mode.

In an exemplary embodiment of the first exemplary embodiment, the suspended connected mode is one of CELL_PCH and URA_PCH.

In an exemplary embodiment of the second exemplary embodiment, the access control information is such as to restrict the wireless device initiating at least one of an RRC Connection Request, a cell update and a UTRAN registration area URA update.

In an exemplary embodiment of the second exemplary embodiment, the access control information is such as to prevent the wireless device initiating at least one of an RRC Connection Request, a UTRAN registration area URA update and a cell update when the update cause is set to either “Uplink data transmission” or “Paging response”.

In an exemplary embodiment of the second exemplary embodiment, the access control information is such as to prevent the wireless device initiating at least one of an RRC Connection Request, a cell update and a UTRAN registration area URA update following receipt by the wireless device of an Earthquake and Tsunami Warning System ETWS primary notification.

In an exemplary embodiment of the second exemplary embodiment, the wireless device starts a timer upon receipt of the ETWS primary notification. The value of the timer may be signaled by the network or held in some pre-stored from by the wireless device.

In an exemplary embodiment of the second exemplary embodiment, the wireless device reverts to normal behavior on expiry of the timer or upon receipt of an ETWS secondary notification. Here, “normal behavior” may be the behavior specified by the access control information in the case that the wireless device is operating in idle mode, or the behavior the wireless device normally has when operating in a suspended connected mode if the wireless device is operating in a suspended connected mode.

In an exemplary embodiment of the second exemplary embodiment, the wireless device operates a timer such as to prevent the wireless device initiating at least one of an RRC Connection Request, a cell update and a UTRAN registration area URA update whilst the timer is running This embodiment is particularly suited to the case that the network is overloaded or becoming overloaded. The value of the timer may be signaled by the network or held in some pre-stored from by the wireless device.

In an exemplary embodiment of the second exemplary embodiment, the access control information is received as part of information relating to at least one of Access Class Barred List, Paging Permission with Access Control PPAC and Domain Specific Access Control DSAC. In an embodiment, the access control information includes an indication that the information applies to a wireless device operating in a suspended connected mode.

In an exemplary embodiment of the second exemplary embodiment, the wireless device operates to inhibit access to the network while the network is updating the access control information. Typically, in a specific example, the wireless device is prohibited from accessing the network until the wireless device has retrieved the updated access control information.

In an exemplary embodiment of the second exemplary embodiment, the suspended connected mode is one of CELL_PCH and URA_PCH.

“Wireless devices” include in general any device capable of connecting wirelessly to a network, and includes in particular mobile devices including mobile or cell phones (including so-called “smart phones”), personal digital assistants, pagers, tablet and laptop computers, content-consumption or generation devices (for music and/or video for example), data cards, USB dongles, etc., as well as fixed or more static devices, such as personal computers, game consoles and other generally static entertainment devices, various other domestic and non-domestic machines and devices, etc. The term “user equipment” or UE is often used to refer to wireless devices in general, and particularly mobile wireless devices.

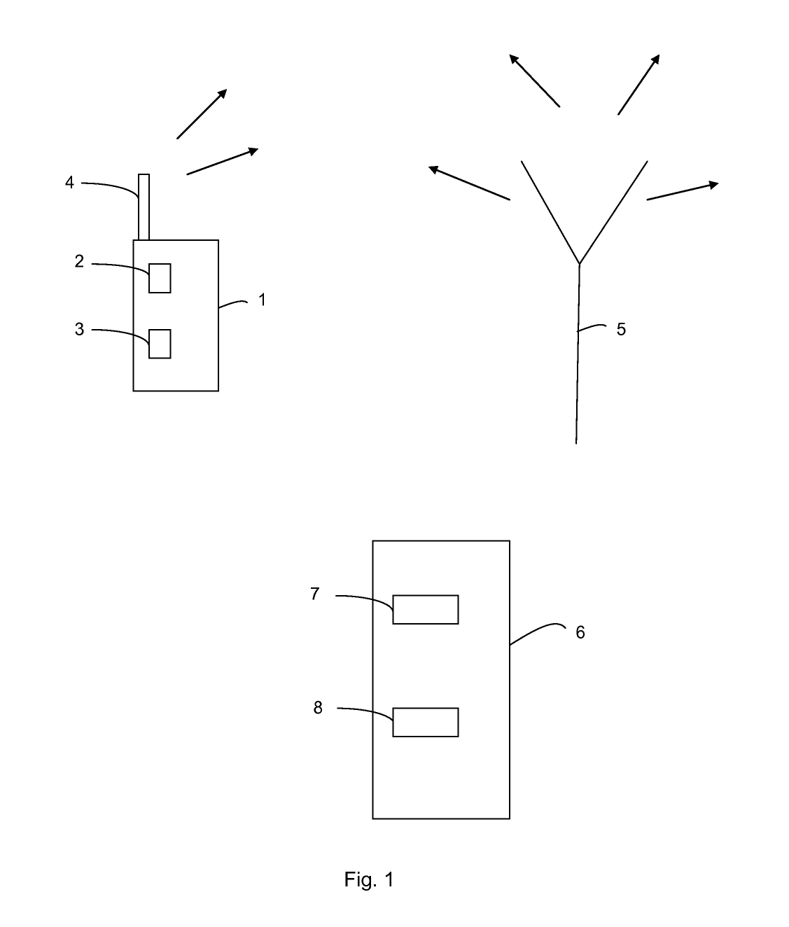

FIG. 1 shows schematically a user equipment or wireless device, in this case in the form of a mobile phone/smartphone 1. The user equipment 1 contains the necessary radio module 2, processor(s) and memory/memories 3, antenna 4, etc. to enable wireless communication with the network. The user equipment 1 in use is in communication with a radio mast 5. As a particular example in the context of UMTS (Universal Mobile Telecommunications System), there may be a network control apparatus 6 (which may be constituted by for example a so-called Radio Network Controller) operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. Moreover for convenience and by convention, the terms “network”, “network control apparatus” and “base station” will often be used interchangeably, depending on the context. The network control apparatus 6 (of whatever type) may have its own processor(s) 7 and memory/memories 8, etc.

Much of the present specification, and particularly the description of the present specific examples, is given in respect of the 3GPP (3rd Generation Partnership Project) cellular wireless system and the UMTS (Universal Mobile Telecommunications System) and LTE (Long Term Evolution) systems in particular. It will be understood however that the principles disclosed herein may be applied to other wireless systems.

The system currently in use in UMTS provides for a number of defined activity states for the user equipment, including an Idle state, a CELL_PCH/URA_PCH (paging channel) state, a CELL_FACH (forward access channel) state, and a CELL_DCH (dedicated channel) state. Similar or analogous states, for all or some of these states, apply for other wireless systems. In the Idle state, the user equipment does not have an RRC (Radio Resource Control) connection and is the state having the lowest power consumption. In the CELL_PCH/URA_PCH state, the user equipment is again in a low power consumption state as it only periodically looks for incoming paging messages, and in this state does have an RRC connection. However, the user equipment needs to be in the CELL_FACH or CELL_DCH state in order to be able to perform both transmission and reception of data (including in particular “user” data, as opposed to data relating to control or management of the device and its network connection, etc. for example). In the CELL_DCH state, a dedicated physical channel is allocated to the user equipment. In the CELL_FACH state, the user equipment shares the physical channel with other user equipment, though nevertheless may have a dedicated logical channel. As is well understood, a logical channel in this context is an information stream dedicated to the transfer of a specific type of information over the radio interface and corresponds to an individual signal which can be separated or isolated from an aggregate of signals which occupy the same physical bandwidth or channel. CELL_FACH can be regarded as a transition state between the idle/CELL_PCH/URA_PCH and CELL_DCH states. Keeping the user equipment in CELL_FACH state improves power consumption for the user equipment compared to the CELL_DCH state (because the transmitter and/or receiver may be switched off for longer periods of time while no uplink data is available and during discontinuous reception or “DRX”) and also reduces the network signaling load (by avoiding radio resource control or “RRC” signaling to perform a state transition from the PCH or Idle states to the CELL_FACH state when both data transmission and reception are required). Nevertheless, the CELL_FACH state still has a higher power consumption for the user equipment than the PCH or Idle states.

In use, in a wireless network, there will typically be occasions where a network operator needs to restrict or control access to the network by wireless devices or UEs. It may be for example that the network is becoming overloaded and therefore access to the network by the wireless devices needs to be controlled in order to prevent congestion and the like. Alternatively or additionally, there will typically be some access to the network that the network would like to prioritize, for example to allow voice calls to or from emergency services to be made, or to ensure that particular messages are likely to be received by the wireless devices.

As some specific examples, there are occasions when many UEs try to make an active connection to the network at around the same time, which can cause congestion problems for the network. This may be at times of large public events, including for example New Year celebrations or the like, when many users attempt to use the network at more or less the same time to make voice calls, send text messages, access social networking accounts and the like. Another example is in the case of an emergency, where again many users may try to make voice calls or send messages or update social networking accounts and the like at approximately the same time.

As another specific example, there is the ETWS (Earthquake and Tsunami Warning System) system which was introduced in 3GPP Release 8 as a public warning system, see for example 3GPP TR 23.828, the entire content of which is hereby incorporated by reference. In that system, when an earthquake or tsunami is detected, the network is used to send a so-called primary notification to all UEs to alert users to the fact that an earthquake has occurred. (The ETWS primary notification can be sent within seconds of the earthquake occurring for example, such that it is received at many UEs even before earthquake tremors are felt by the users.) However, it has been observed that practically immediately following receipt of the ETWS primary notification, many of the UEs attempt to send signals across the network. It has been found that this is not because the users are attempting to make voice calls or send text messages, etc. Rather, it is because there are applications running on the UEs that buffer data or suspend real time information when the UE is not active, as indicated for example by a backlight of the UE's display screen being turned off. When the ETWS primary notification is received by the UE, the UE becomes active, as indicated by the backlight of the UE turning on. At that point, the UE attempts to send the buffered data or update real time information. This occurs for very many of the UEs at practically the same time, which causes a huge increase in signaling. See for example the document R2-125594 entitled “UTRAN issue about the burst traffic caused by ETWS” by NTT DoCoMo, Inc. This causes congestion in the network, and can also prevent the UEs receiving an ETWS secondary notification, which is sent as a CBS or Cell Broadcast Service message shortly after the ETWS primary notification to inform users of the location of the epicenter of the earthquake, the magnitude of the earthquake, the location of safe areas and food and shelter, etc., etc. Moreover, at least as currently specified, the ETWS secondary notification in a UTRA network can normally or mostly be received only when the UE is in Idle mode or CELL/URA_PCH mode. In their document R2-125596, DoCoMo propose some solutions for this, but these rely on the UE always receiving an ETWS secondary notification, whereas in practice an ETWS secondary notification may not be received by the UE and may not even be sent by the network in the first place, or apply when some “high priority” call is to be made, though there is no detailed discussion of what constitutes a “high priority” call or how that information might be relayed to or by the network.

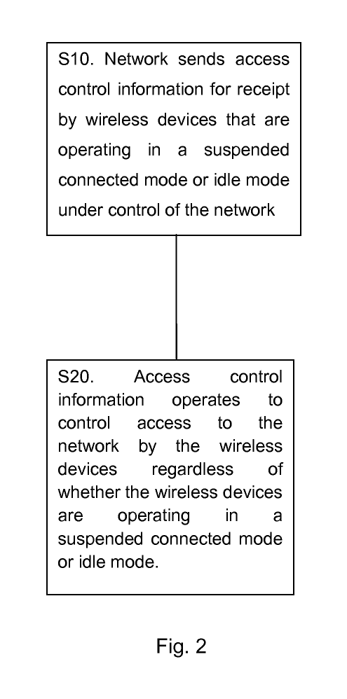

Referring to FIG. 2, an example of an embodiment of the present invention operates broadly as follows. At S10, a network sends access control information for receipt by wireless devices that are operating in a suspended connected mode or idle mode under control of the network. As indicated at S20, the access control information operates to control access to the network by the wireless devices regardless of whether the wireless devices are operating in a suspended connected mode or idle mode.

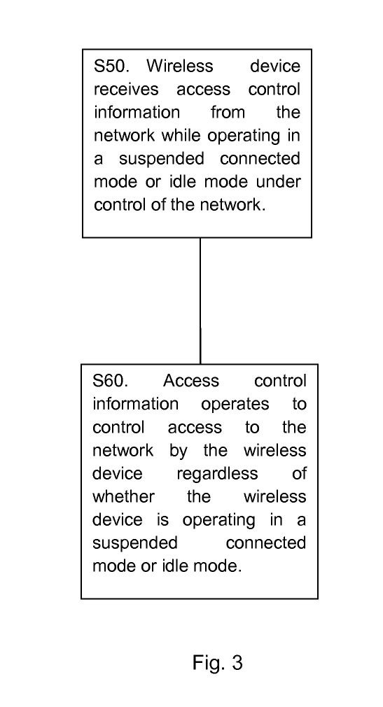

Referring to FIG. 3, another example of an embodiment of the present invention operates broadly as follows. At S50, a wireless device receives access control information from the network while operating in a suspended connected mode or idle mode under control of the network. As indicated at S60, the access control information operates to control access to the network by the wireless device regardless of whether the wireless device is operating in a suspended connected mode or idle mode.

Examples of embodiments of the present invention enable the network to limit access to the network by UEs, regardless of whether the UEs are operating in an idle mode or some suspended connected mode such as a paging channel state, such as CELL_PCH or URA_PCH for example. In this regard, if for example a UE is in an active connected state (including for example a CELL_FACH (forward access channel) state or a CELL_DCH (dedicated channel) state), then it is typically relatively straightforward for the network to release signaling connections if needed and/or move the RRC connection to a suspended connected mode, such as a paging channel state. However, with current (prior art) proposals, limiting access to the network by UEs that are in an idle mode or some suspended connected mode such as a paging channel state is not readily achievable.

In one specific example that is particularly relevant for the ETWS (Earthquake and Tsunami Warning System) case, the operation may be as follows. The network sends an ETWS primary notification for receipt by UEs operating under control of the network. In one example, when the network sends the ETWS primary notification, it may also include the information element “BCCH Modification Info” with the information element “ETWS Info” or some other similar indication in the same RRC message (which may be for example either the Paging Type 1 or System Information Change Indication message) to indicate that a new system information (SI) is available/being sent. In addition, an access control mechanism is used to restrict the UEs initiating a cell update or URA update procedure. This may be for certain cases only, such as when the cell update cause is set to either “Uplink data transmission” or “Paging response” and/or for example when the UE receives the ETWS primary notification whilst operating in idle mode or a suspended connected state such as the CELL_PCH state or URA_PCH state. The access control mechanism may be for example one (or more) of Access Class Barred List, DSAC (Domain Specific Access Control) and PPAC (Paging Permission with Access Control).

Each of Access Class Barred List, DSAC and PPAC is a technique that is well known per se and will therefore not be discussed in detail herein. Very briefly, the Access Class of a particular user is typically stored in the user's wireless device, such as on a SIM card of the device. “Common” or ordinary users may for example be provided with limited access when for example a network is congested, whereas for example users associated with police or emergency services or the like may be prioritized by the network. DSAC was introduced initially to allow network operators to allow packet switched connections to continue even if circuit switched connections were congested or vice versa (because for example there is a lot of voice traffic, perhaps following an emergency for example). PPAC was introduced so that even in an emergency situation, where the network can get congested and as a result all access is barred except for emergency services, a user can still be paged and therefore called by the emergency services. However, to date, these access control mechanisms have not been able to be used for UEs that are in what may be called a “suspended connected” state, including for example the paging channel CELL_PCH and URA_PCH states or modes, and thus there has so far been no mechanism for the network to control UEs that are in a suspended connected state.

In this example, however, regardless of whether the receiving UE is in the idle state or a paging channel state or other suspended connected state, the transmission of RRC Connection Requests (if the UE is in the idle state) and Cell Update/URA Update messages (if the UE is in a suspended connected state, such as a paging channel state) by the UE are blocked or inhibited. In particular, having received an indication that a new system information (SI) is available/being sent, the UE is prohibited from sending a RRC Connection Request, a Cell Update message or a URA Update message until the UE has retrieved the updated system information or SI. Thus, the UE is effectively blocked from trying to move from Idle mode or CELL_PCH or URA_PCH mode before the new SI has been read in the case that the ETWS primary notification has been received. This means that new signaling connections or resumption of sending of cell/URA update messages are blocked until acquisition of the new SI in the case that the UE has received the ETWS primary notification and, in this example, a BCCH modification as discussed above that is triggered simultaneously. This in itself serves to keep down the network traffic that UEs have in the past initiated upon receipt of an ETWS primary notification as discussed in more detail above.

Continuing the discussion of this example, the UE then acquires and re-reads the SI sent by the network and evaluates the access control information (i.e., in the specific examples discussed here, the Access Class Barred List, DSAC or PPAC as the case may be) contained in the updated SI. The UE may restrict the barred services in accordance with the received access control information, as is known per se.

In one example of this, a guard timer is used at the UE. The value of the guard timer may be signaled by the network, but preferably the value of the guard timer is pre-stored by the UEs. In this example, the timer is started by the UE upon receipt of the ETWS primary notification. While the timer is running, the UE applies the normal Access Class Barred List/PPAC/DSAC rules also to Cell/URA update for PS (packet switched) domain triggers, which in effect prevents the UE making new connections to the network or resuming connections to the network and thus prevents the network becoming congested. If the ETWS secondary notification is received, then the timer is stopped, which is deemed acceptable because the purpose of allowing the ETWS secondary notification to be received has been achieved. If the timer expires, then the UE reverts to normal Access Class Barred List/PPAC/DSAC behavior, which is deemed acceptable because it may be assumed after a period of time that for example no ETWS secondary notification is being sent by the network, or at least cannot be received within a reasonable time by the UE, and therefore the UE can resume “normal” behavior.

In another specific example that is particularly relevant for the case that the network is becoming overloaded and it is desired to control access to the network by the UEs, operation may be as follows. The network initially signals that the network supports the present enhancement (by using for example a new flag #1) in the system information (SI). When the network detects that the network is becoming overloaded, the network signals a new flag (by using for example a new flag #2) in the SI and, in one example, the UE is informed about the SI modification via a BCCH modification. The UE re-acquires the SI upon the BCCH modification and as a result blocks leaving the idle mode/CELL_PCH/URA_PCH states until the completion of the SI acquisition if the new flag #1 was previously present in the SI.

In addition, similarly to the first example above for the ETWS case, an access control mechanism is used to restrict the UEs initiating a cell update or URA update procedure when the second flag #2 has been set and received by the UEs. This may be for certain cases only, such as when the cell update cause is set to either “Uplink data transmission” or “Paging response”, and applies whether the UE is operating in idle mode or a suspended connected state such as the CELL_PCH state or URA_PCH state. The access control mechanism may be for example one (or more) of Access Class Barred List, DSAC (Domain Specific Access Control) and PPAC (Paging Permission with Access Control), as discussed in more detail above. After the acquisition of the new SI, the UE evaluates the access control parameters given by the re-acquired SI and applies the access restriction for Cell Update and URA Update cases in the case that the second flag #2 has been set.

In one example of this, a guard timer is used at the UE. The UE may start the guard timer when for example it re-acquires the SI or has evaluated the access control parameters. In this case, the UE applies the access control for Cell Update/URA Update while the timer is running The UE moves back to a normal operation (i.e. the access control is no longer applied for Cell Update/URA Update) when the guard timer expires.

In either of the two main examples discussed above, the use of a guard timer prevents the UE from restricting or preventing the subsequent RRC connection establishment and initiating a cell update/URA update procedure forever. The UE can revert to normal operation when the timer expires.

In either of the two main examples discussed above, the access control mechanism gives clear prioritization information to the UE: the UE knows what type of call is to be restricted and what type of call can be set up. This is the case regardless of whether the UE was in idle mode or a suspended connected state, such as a paging channel state such as the CELL_PCH or URA_PCH state.

Moreover, examples of embodiments of the present invention do not require any update to the RRC interface and so are implementable for legacy 3GPP release UEs in a straightforward manner.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of controlling operation of wireless devices operating under network control, the method comprising:
the network sending access control information for receipt by wireless devices that are operating in a suspended connected mode or idle mode under control of the network, the access control information operating to control access to the network by the wireless devices regardless of whether the wireless devices are operating in a suspended connected mode or idle mode.

2. A method of controlling operation of a wireless device operating under network control, the method comprising:
the wireless device receiving access control information from the network while operating in a suspended connected mode or idle mode under control of the network, the access control information operating to control access to the network by the wireless device regardless of whether the wireless device is operating in a suspended connected mode or idle mode.

3. Apparatus for controlling operation of wireless devices operating under network control, the apparatus comprising:
at least one processor;
and at least one memory including computer program code;
the at least one memory and the computer program code being configured to, with the at least one processor, cause the apparatus at least to:
send access control information for receipt by wireless devices that are operating in a suspended connected mode or idle mode under control of the network, the access control information operating to control access to the network by the wireless devices regardless of whether the wireless devices are operating in a suspended connected mode or idle mode.

4. Apparatus according to claim 3, wherein the access control information is such as to restrict a wireless device initiating at least one of an RRC Connection Request, a cell update and a UTRAN registration area URA update.

5. Apparatus according to claim 3, wherein the access control information is such as to prevent a wireless device initiating at least one of an RRC Connection Request, a UTRAN registration area URA update and a cell update when the update cause is set to either “Uplink data transmission” or “Paging response”.

6. Apparatus according to claim 3, wherein the access control information is such as to prevent a wireless device initiating at least one of an RRC Connection Request, a cell update and a UTRAN registration area URA update following receipt by the wireless device of an Earthquake and Tsunami Warning System ETWS primary notification.

7. Apparatus according to claim 3, wherein the access control information is sent as part of information relating to at least one of Access Class Barred List, Paging Permission with Access Control PPAC and Domain Specific Access Control DSAC.

8. Apparatus according to claim 7, wherein the access control information includes an indication that the information applies to a wireless device operating in a suspended connected mode.

9. Apparatus according to claim 3, wherein the suspended connected mode is one of CELL_PCH and URA_PCH.

10. Apparatus for a wireless device operating under network control, the apparatus comprising:
at least one processor;
and at least one memory including computer program code;
the at least one memory and the computer program code being configured to, with the at least one processor, cause the apparatus at least to:
control access to the network by the wireless device in accordance with access control information received from the network while the wireless device is operating in a suspended connected mode or idle mode under control of the network, the access control information operating to control access to the network by the wireless device regardless of whether the wireless device is operating in a suspended connected mode or idle mode.

11. Apparatus according to claim 10, wherein the access control information is such as to restrict the wireless device initiating at least one of an RRC Connection Request, a cell update and a UTRAN registration area URA update.

12. Apparatus according to claim 10, wherein the access control information is such as to prevent the wireless device initiating at least one of an RRC Connection Request, a UTRAN registration area URA update and a cell update when the update cause is set to either “Uplink data transmission” or “Paging response”.

13. Apparatus according to claim 10, wherein the access control information is such as to prevent the wireless device initiating at least one of an RRC Connection Request, a cell update and a UTRAN registration area URA update following receipt by the wireless device of an Earthquake and Tsunami Warning System ETWS primary notification.

14. Apparatus according to claim 13, arranged such that the wireless device starts a timer upon receipt of the ETWS primary notification.

15. Apparatus according to claim 14, arranged such that the wireless device reverts to normal behavior on expiry of the timer or upon receipt of an ETWS secondary notification.

16. Apparatus according to claim 12, arranged such that the wireless device operates a timer such as to prevent the wireless device initiating at least one of an RRC Connection Request, a cell update and a UTRAN registration area URA update whilst the timer is running

17. Apparatus according to claim 10, wherein the access control information is received as part of information relating to at least one of Access Class Barred List, Paging Permission with Access Control PPAC and Domain Specific Access Control DSAC.

18. Apparatus according to claim 17, wherein the access control information includes an indication that the information applies to a wireless device operating in a suspended connected mode.

19. Apparatus according to claim 10, arranged such that the wireless device operates to inhibit access to the network while the network is updating the access control information.

20. Apparatus according to claim 10, wherein the suspended connected mode is one of CELL_PCH and URA_PCH.
